(19) United States
(12) Patent Application Publication
(10) Pub. No.: US 2015/0264346 A1
(43) Pub. Date: Sep. 17, 2015

(54) VIDEO ENCODING DEVICE AND VIDEO ENCODING METHOD

(71) Applicant: FUJITSU LIMITED, Kawasaki-shi (JP)

(72) Inventors: Hiroaki Yamashita, Fukuoka (JP); YASUO MISUDA, Inagi (JP)

(21) Appl. No.: 14/633,648

(22) Filed: Feb. 27, 2015

(30) Foreign Application Priority Data
Mar. 17, 2014 (JP) 2014-054169

(51) Int. Cl. H04N 19/103; H04N 19/157; H04N 19/147; H04N 19/176

(52) U.S. Cl. CPC H04N 19/103; H04N 19/176; H04N 19/157; H04N 19/147

(57) ABSTRACT

A video encoding device includes: a processor configured to execute a process including: when successively encoding a plurality of blocks obtained by dividing a frame image in a predetermined period, selecting an encoding mode by which each block is encoded, in accordance with a progress status of encoding of the blocks; and successively encoding each block of the frame image in the selected encoding mode.

### CROSS-REFERENCE TO RELATED APPLICATIONS

This application is based upon and claims the benefit of priority of the prior Japanese Patent Application No. 2014-054169, filed on Mar. 17, 2014, the entire contents of which are incorporated herein by reference.

### FIELD

The embodiments discussed herein are related to a video encoding device, a video encoding method, and a video encoding program.

### BACKGROUND

Video encoding methods for encoding a video image in real time have conventionally been known. Examples of the video encoding methods include H.264/MPEG (Moving Picture Experts Group)-4AVC (Advanced Video Coding) and H.265. H.265 is also called HEVC (High Efficiency Video Coding). “H.264/MPEG-4AVC” is hereinafter also denoted as “H.264”. In this video encoding method, a plurality of encoding modes are defined. In this video encoding method, in order to improve compression efficiency and image quality, a frame image is divided into a plurality of macroblocks and the optimum encoding mode is selected on a macroblock basis for performing an encoding process. For example, in the video encoding method, the cost of encoding in each encoding mode is obtained and an encoding mode with a small cost is selected for performing an encoding process. The cost is calculated from, for example, a distortion of the encoded image and the volume of information produced by encoding. Conventional examples are described in Japanese National Publication of International Patent Application No. 2004-532540, Japanese Laid-open Patent Publication No. 2007-159111, Japanese Laid-open Patent Publication No. 2002-112274.

To encode a video image in real time, encoding of a frame image has to be performed in a period corresponding to a frame period of the video image. However, even when an encoding mode with a small cost is selected, encoding of a frame image is not always completed in a period corresponding to a frame period. In such a case, for example, encoding by the encoding mode may be skipped for a macroblock not yet encoded, and information of the macroblock of the previous frame may be used. This processing, however, reduces image quality.

### SUMMARY

According to an aspect of an embodiment, a video encoding device includes: a processor that executes a process including: when successively encoding a plurality of blocks obtained by dividing a frame image in a predetermined period, selecting an encoding mode by which each block is encoded, in accordance with a progress status of encoding of the blocks; and successively encoding each block of the frame image in the selected encoding mode.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a schematic configuration of a video encoding device;

FIG. 2 is a diagram illustrating an example of a schematic configuration of a mode select controller;

FIG. 3 illustrates prediction modes of intra prediction;

FIG. 4 is a table illustrating an example of corrections on costs;

FIG. 5 is a table illustrating an example of the calculated cost correction value in each encoding mode;

FIG. 6 is a flowchart illustrating an example procedure of a video encoding process;

FIG. 7 is a graph illustrating an example of changes in the progress status of encoding of a frame image;

FIG. 8 is a table illustrating an example of corrections on costs;

FIG. 9 is a graph representing an example of changes in the progress status of encoding of a frame image;

FIG. 10 is a table illustrating an example of corrections on costs; and

FIG. 11 is a diagram illustrating a computer that executes a video encoding program.

### DESCRIPTION OF EMBODIMENTS

Preferred Embodiments of the Present Invention will be explained with reference to accompanying drawings. The embodiments herein are not intended to limit the scope of the invention. The embodiments can be combined appropriately as long as the various types of processes performed in the embodiments are not contradictory to each other. In the following, an example of encoding with H.264 will be mainly described.

### [a] First Embodiment

Configuration of a Video Encoding Device

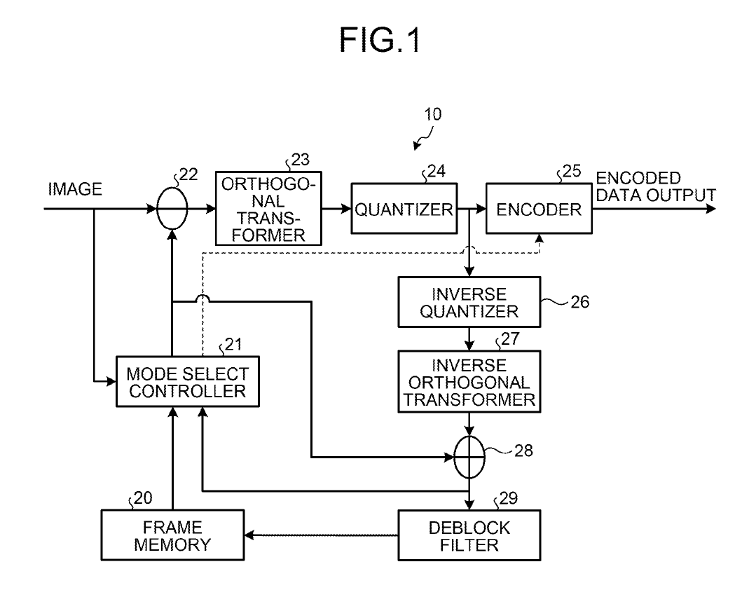

A configuration of a video encoding device 10 according to a first embodiment will be described. FIG. 1 is a diagram illustrating an example of a schematic configuration of the video encoding device. The video encoding device 10 is a device for encoding an input video image in real time. The video encoding device 10 may be a transcoder LSI (Large Scale Integration), which is implemented as a single LSI chip. Alternatively, the video encoding device 10 may be a board mounted with equipment for use in encoding a video image.

A procedure by which the video encoding device 10 encodes a video image will now be described briefly. Data of a video image to be encoded is input to the video encoding device 10. For example, when a video image is captured at a frame rate of 30 frames, data of each frame image of the video image is input to the video encoding device 10 every 1/30 seconds. The video encoding device 10 encodes each frame image in a predetermined period corresponding to the frame period. For example, the video encoding device 10 divides a frame image into a plurality of macroblocks. The video encoding device 10 then successively sets an image of each macroblock of the frame image as an encoding target block and calculates costs for processes of encoding the encoding target block in a variety of encoding modes. For example, the video encoding device 10 calculates costs for processes of intra prediction and of inter prediction for each macroblock. Intra prediction refers to predicting the pixels of an encoding target block from the pixels of another block in the same frame image. This intra prediction is also called intra-frame prediction. Inter prediction refers to predicting the pixels of an encoding target block by performing motion compensation between frame images. This inter prediction is also called inter-frame prediction. The video encoding device 10 then encodes the image of a macroblock in the encoding format with the smallest cost.

In the example in FIG. 1, the procedure for encoding a frame image on a macroblock basis is illustrated by a functional configuration. As illustrated in FIG. 1, the video encoding device 10 includes, as processing units for encoding a video image, a frame memory 20, a mode select controller 21, a subtractor 22, an orthogonal transformer 23, a quantizer 24, and an encoder 25. The video encoding device 10 also includes, as processing units for encoding a video image, an inverse quantizer 26, an inverse orthogonal transformer 27, an adder 28, and a deblock filter 29. The whole or any part of the processing units may be implemented by, for example, a central processing unit (CPU) and a computer program to be analyzed and executed on the CPU or may be implemented by hardware such as an LSI or wired logic.

A frame image to be compared during encoding is stored in the frame memory 20. For example, encoded frame images of up to 16 frames are stored in the frame memory 20.

A frame image is input to the mode select controller 21. The mode select controller 21 obtains motion vectors for the input frame image on a macroblock basis from each frame image stored in the frame memory 20. The mode select controller 21 then performs motion compensation for each frame image based on the motion vectors. The mode select controller 21 then obtains a prediction error between the image of the encoding target block and the image of the part corresponding to the encoding target block that has been motion-compensated, and calculates the cost of encoding.

The image of the encoded block of the frame image is also input from the adder 28 to the mode select controller 21. The mode select controller 21 predicts the image of the encoding target block from the images of the encoded blocks neighboring the encoding target block, obtains a prediction error between the predicted image and the actual image, and calculates the cost of encoding.

The mode select controller 21 corrects the calculated cost of encoding and selects an encoding mode from the corrected cost. The details of the process of correcting the cost of encoding and selecting an encoding mode from the corrected cost will be described later. The mode select controller 21 outputs the image of the part corresponding to the encoding target block in the selected encoding mode to the subtractor 22. The mode select controller 21 also outputs information for use in encoding in the selected encoding mode to the encoder 25.

The subtractor 22 obtains a prediction error image between the image of the encoding target block and the image selected by the mode select controller 21 and outputs the obtained prediction error image to the orthogonal transformer 23. The orthogonal transformer 23 performs orthogonal transformation of the input prediction error image into data in the spatial frequency domain. For example, in the H.264 format, the orthogonal transformer 23 performs discrete cosine transformation (DCT) of the prediction error image with integer precision into data in the spatial frequency domain. The quantizer 24 quantizes the data transformed by the orthogonal transformer 23, thereby reducing the information volume of the data. The encoder 25 encodes data quantized by the quantizer 24 and adds supplemental information such as the encoding mode to the encoded data for output.

The inverse quantizer 26 inversely quantizes the data quantized by the quantizer 24 into data in the spatial frequency domain. The inverse orthogonal transformer 27 performs inverse orthogonal transformation of the data in the spatial frequency domain converted by the inverse quantizer 26 into data of the prediction error image. The adder 28 adds the image selected by the mode select controller 21 to the prediction error image to generate a restored image of a macroblock and outputs the generated image to the mode select controller 21 and the deblock filter 29. In the mode select controller 21, this restored image of a macroblock serves as an image to be used for prediction when intra prediction for a subsequent macroblock image is performed.

The deblock filter 29 performs a deblocking filter process on the restored image of each macroblock output from the adder 28 and makes block noise correction between macroblocks. For example, the deblock filter 29 accumulates one frame of restored images of macroblocks output from the adder 28 and smoothes the boundary between the accumulated restored images of macroblocks with adaptive weights. Block noise at the boundary of the restored images is thus reduced. The frame image processed by the deblock filter 29 is stored into the frame memory 20 for use in intra prediction.

Configuration of Mode Select Controller

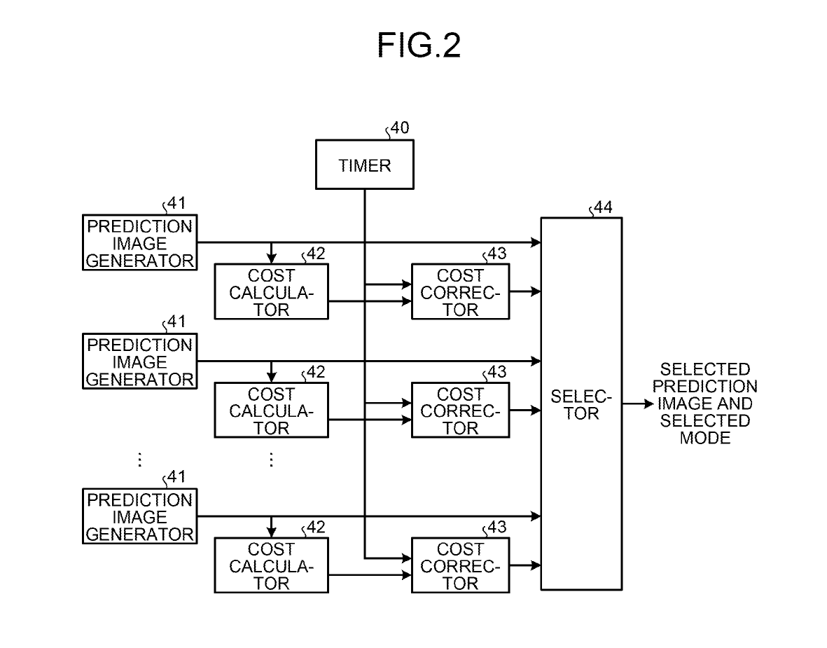

A configuration of the mode select controller 21 will now be described. FIG. 2 is a diagram illustrating an example of a schematic configuration of the mode select controller. In the example in FIG. 2, the procedure by which the mode select controller 21 selects an encoding mode is illustrated by a functional configuration. As illustrated in FIG. 2, the mode select controller 21 includes a timer 40, prediction image generators 41, cost calculators 42, cost correctors 43, and a selector 44.

The timer 40 measures the elapsed time. For example, the timer 40 measures, for each frame image, the elapsed time since encoding of the frame image was started. The timer 40 also measures, for each macroblock of a frame image, the processing time taken for the processing in each encoding mode described later.

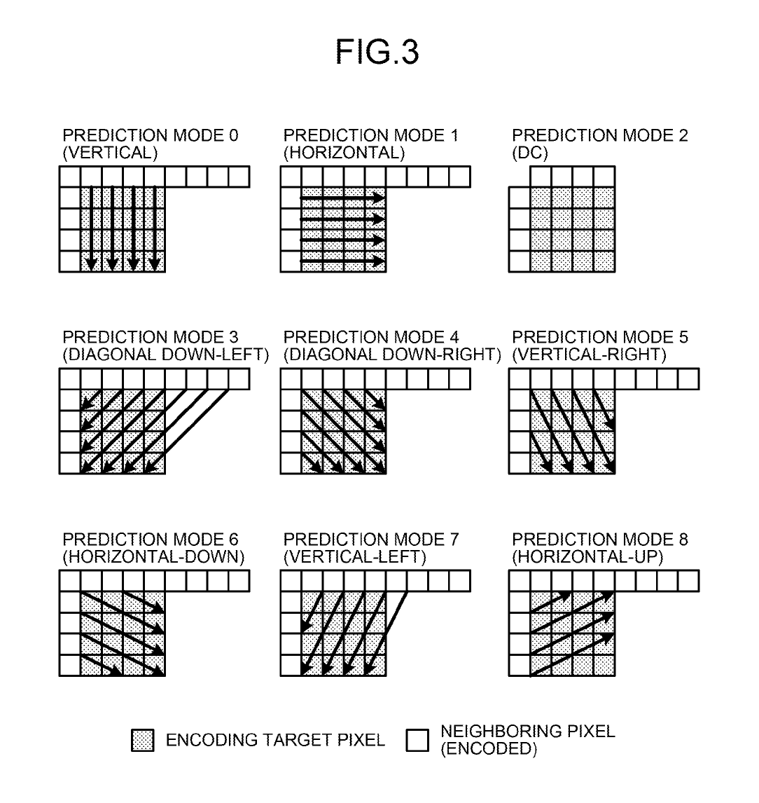

The prediction image generator 41, the cost calculator 42, and the cost corrector 43 are provided for each encoding mode. Although in the example in FIG. 2 three sets of the prediction image generator 41, the cost calculator 42, and the cost corrector 43 are illustrated, the disclosed system is not limited thereto as long as one set of these is provided for each encoding mode. For example, in inter prediction, in order to obtain a prediction error from each of a plurality of frame images stored in the frame memory 20, the prediction image generator 41, the cost calculator 42, and the cost corrector 43 are provided for each encoding mode for obtaining a prediction error. In intra prediction, in order to obtain a prediction error by predicting the pixels of an encoding target block in a plurality of prediction modes from the encoded neighboring pixels, the prediction image generator 41, the cost calculator 42, and the cost corrector 43 are provided for each prediction mode of intra prediction. FIG. 3 illustrates prediction modes of intra prediction. In intra prediction, prediction mode 0 to prediction mode 8 are defined as prediction modes for the pixels of an encoding target block. In the example in FIG. 3, the neighboring pixels applied as prediction values to the encoding target block are indicated by the arrows. For example, in prediction mode 0, the values of the upper pixels are applied as the prediction values for the lower pixels. In prediction mode 2, the mean value of the neighboring pixels is applied as a prediction value. The prediction image generator 41, the cost calculator 42, and the cost corrector 43 are thus provided corresponding to each of prediction modes 0 to 8.

Here, in intra prediction of H.264, a prediction image is generated from the neighboring pixels in a unit size of 4 by 4 or 16 by 16 pixels, and the processing volume widely varies among prediction modes. For example, as illustrated in FIG. 3, in the case of prediction modes 0 and 1, a prediction image is generated by copying the neighboring pixels. By contrast, in prediction modes 3 to 8, a prediction image is generated by performing a filter process of multiplying the neighboring pixels by a coefficient and adding the result. That is, compared with prediction modes 0 and 1, prediction modes 3 to 8 involve a significantly larger operation volume and longer processing time for prediction image generation, resulting in variations in processing time. In H.265, the number of prediction modes increases about four times and, in addition, the filter process for prediction image generation requires more pixels and more operation volume. In H.265, therefore, the difference in processing time among prediction modes is greater.

In inter prediction of H.264, a motion vector and a prediction image are generated with a size that takes the smallest encoding cost among the sizes from the smallest size of 4 by 4 pixels to the largest size of 16 by 16. In doing so, when comparison is made between the cases where a prediction image is generated four times by performing a motion search with the 4-by-4 size and where a prediction image is generated once by performing a motion search with the 16-by-16 size, a single operation with the 16-by-16 size takes a shorter processing time than four operations with the 4-by-4 size. The reason for this is that, in the case of the 16-by-16 size, a prediction image can be generated from a picture indicated by a single vector. On the other hand, in the case of processing the 4-by-4 size four times, each vector can refer to different pictures and therefore when a prediction image is generated, access to the small rectangular size of 4 by 4 pixels is performed four times. With the 4-by-4 size, the total memory transfer time thus increases. In inter prediction, the reference image to be read out is stored, for example, in a mass-storage memory such as a DRAM. It is difficult to take advantage of the burst transfer function of the DRAM for the readout of such a small rectangular size as 4 by 4 pixels. The readout of such a small rectangular size has poor access efficiency. In the case of the 4-by-4 size, the amount of produced vectors as well as the volume of processing for encoding vector information is four times as much as that of the 16-by-16 size, leading to increase in processing time. Moreover, in the case of H.265, the largest size is extended to 64 by 64 pixels, and the difference between the minimum processing volume and the maximum processing volume is even greater.

The prediction image generator 41 generates a prediction image for each encoding mode.

The cost calculator 42 calculates the cost of encoding. For example, the cost calculator 42 calculates a distortion D caused when encoding is performed in an encoding mode, and information R for encoding. For example, the cost calculator 42 compares the image of an encoding target block with the prediction image generated by the prediction image generator 41 for each corresponding pixel and calculates the sum of squared errors of the pixel values as the distortion D. For example, the cost calculator 42 calculates the volume of information generated when encoding is performed in an encoding mode, motion vectors, and encoding mode information, as information R for encoding. The cost calculator 42 calculates a value as cost J by adding distortion D and information R for encoding. That is, the cost calculator 42 calculates cost J by adding distortion D and information R for encoding.

The cost corrector 43 corrects cost J calculated by the cost calculator 42. For example, the cost corrector 43 corrects cost J by adding cost correction value τ for each encoding mode to cost J.

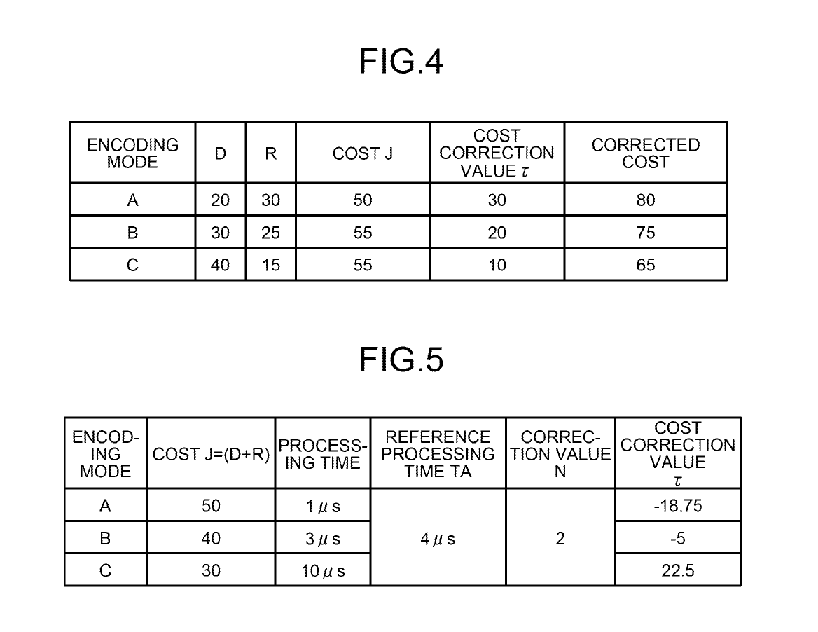

FIG. 4 is a table illustrating an example of corrections on costs. In the example in FIG. 4, for encoding modes A to C, distortion D, information R for encoding, cost J, cost correction value τ, and the corrected cost are illustrated. For example, in encoding mode A, given distortion D is “20” and information R for encoding is “30”, adding “20” and “30” results in cost J of “50”. In encoding mode A, given cost J is “50” and cost correction value τ is “30”, adding “50” and “30” results in the corrected cost of “80”. In encoding mode C, given distortion D is “40” and information R for encoding is “15”, adding “40” and “15” results in cost J of “55”. In encoding mode C, given cost J is “55” and cost correction value τ is “10”, adding “55” and “10” results in the corrected cost of “65”.

The cost correction value τ may be set in advance greater for the encoding mode with a greater processing load. For example, the higher the processing load for encoding is, the greater the value may be set. The value of cost correction value τ may be adjusted, for example, by the administrator. Alternatively, cost correction value τ may be calculated.

An example of calculating cost correction value T will now be described. For example, the timer 40 measures the processing time taken for the processing in each encoding mode. The cost corrector 43 then calculates cost correction value τ from the time and the cost value taken for the processing in each encoding mode and the reference processing time of a macroblock.

For example, let T be the processing time in an encoding mode, J be the cost value, TA be the reference processing time, and N be the correction value. In this case, cost correction value τ is calculated, for example, by Expression (1) below.

τ=(J×(T/TA)−J)/N (1)

The correction value N is a coefficient for adjusting the degree of correction. For example, the correction value N is a numerical value such as “1” or “4”.

A specific example of calculating cost correction value τ will be described. For example, when a frame image having a size of 1920 by 1088 pixels is processed at a rate of 30 frames per second, the time available for processing one frame image is 33333.33 . . . μs. When a macroblock has a size of 16 by 16 pixels, the number of macroblocks in a frame image having a size of 1920 by 1088 pixels is 120×68=8160 with 1920/16=120 macroblocks in the horizontal direction and 1088/16=68 macroblocks in the vertical direction. The time available for processing a single macroblock is 33333.33 . . . /8160 μs, that is, approximately 4 μs. This is set as a reference processing time TA.

FIG. 5 is a table illustrating an example of the calculated cost correction value for each encoding mode. As illustrated in FIG. 5, for encoding mode A, the processing time is 1 μs and the cost value J is 50. For encoding mode B, the processing time is 3 μs and the cost value J is 40. For encoding mode C, the processing time is 10 μs and the cost value J is 30. The reference processing time TA is 4 μs and the correction value N is 2.

In this case, cost correction value τ is calculated for each mode as follows.

(50×(1 μs/4 μs)−50)/2=−18.75 Encoding mode A:

(40×(3 μs/4 μs)−40)/2=−5 Encoding mode B:

(30×(10 μs/4 μs)−30)/2=22.5 Encoding mode C:

The selector 44 selects an encoding mode based on the cost corrected by the cost corrector 43. For example, the selector 44 selects the encoding mode for which the corrected cost is small. For example, the selector 44 selects encoding mode C in the case of the example in FIG. 4. The prediction image in the selected encoding mode is output to the subtractor 22, so that the image of the encoding target block is encoded.

As described above, the video encoding device 10 calculates cost J of encoding for each encoding mode and selects an encoding mode based on the cost obtained by correcting cost J with cost correction value τ, thereby preventing delay in encoding a frame image. The macroblocks of a frame image can be encoded in any one of the encoding modes, and the encoding results in less image quality reduction.

Process Procedure

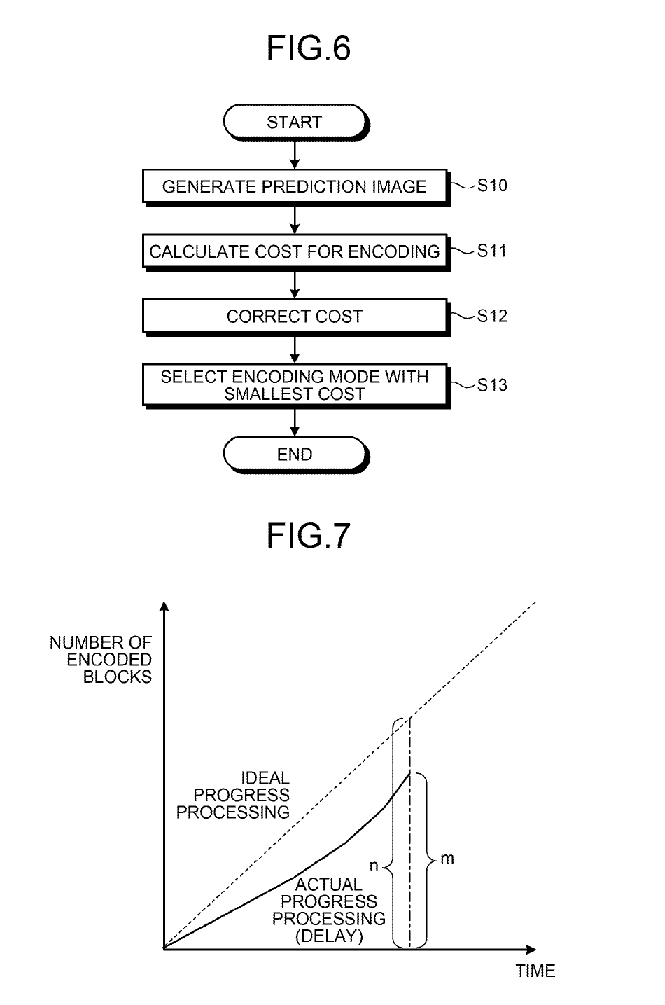

The procedure of a video encoding process by which the video encoding device 10 in the present embodiment encodes a video image will now be described. FIG. 6 is a flowchart illustrating an example procedure of the video encoding process. This video encoding process is performed at a predetermined timing, for example, at the timing when each macroblock of a frame image is encoded.

As illustrated in FIG. 6, the prediction image generator 41 generates a prediction image in each encoding mode (S10). The cost calculator 42 then calculates cost J of encoding in each encoding mode (S11). The cost corrector 43 corrects cost J of encoding in each encoding mode that is calculated by the cost calculator (S12). The selector 44 selects the encoding mode in which the corrected cost is small (S13). The process then ends. As described above, in the video encoding device 10, an encoding mode for encoding each block is thus selected in accordance with the progress status of encoding of a plurality of blocks. In the video encoding device 10, the process illustrated in FIG. 6 is performed on a macroblock, and encoding is performed in the selected encoding mode.

### Advantageous Effects

As described above, the video encoding device 10 according to the present embodiment successively encodes a plurality of blocks obtained by dividing a frame image. The video encoding device 10 then selects an encoding mode for encoding each block in accordance with the progress status of encoding of the blocks in a predetermined period corresponding to a frame period. Accordingly, the video encoding device 10 can encode a video image in real time with less image quality reduction.

The video encoding device 10 according to the present embodiment selects an encoding mode based on the value obtained by correcting the cost of encoding for each encoding mode with a correction value corresponding to the encoding mode. The video encoding device 10 thus can prevent delay in encoding a frame image.

### [b] Second Embodiment

A second embodiment will now be described. The configuration of the video encoding device 10 according to the second embodiment is the same as the first embodiment and the difference is mainly described.

The cost corrector 43 obtains the progress status of encoding for each frame image. For example, the cost corrector 43 calculates the progress status of encoding within a frame image from the time measured by the timer 40 and the proportion of macroblocks encoded in the frame image. For example, the cost corrector 43 calculates coefficient γ indicating the state of delay, for example, by Expression (2) below, from the difference between the number of blocks n encoded with the ideal progress and the number of blocks m actually encoded at the time of the mode determination process, as the progress status of encoding within a frame image.

γ=(n−m)/n (2)

FIG. 7 is a graph illustrating an example of changes in the progress status of encoding of a frame image. The horizontal axis in FIG. 7 represents the time. The vertical axis in FIG. 7 represents the number of blocks encoded in a frame image. The broken line in FIG. 7 represents the progress status of ideal processing in encoding each macroblock in a frame image in a frame period. Here, as depicted in FIG. 7, when the actual progress status of encoding of a frame image lags behind the progress status of ideal processing, the number of blocks m actually encoded is smaller than the number of blocks n encoded with the ideal progress. Therefore, when the process lags behind the ideal processing, coefficient γ is found in a range of 0.0 to 1.0.

The cost corrector 43 corrects cost correction value τ using the calculated value of coefficient γ. For example, the cost corrector 43 makes a correction by multiplying cost correction value τ by coefficient γ in a delay state. The method of correcting cost correction value τ is not limited thereto.

The cost corrector 43 then calculates the corrected cost by adding cost correction value τ to cost J for each encoding mode. In this case, the corrected cost is calculated, for example, by Expression (3) below.

Corrected cost=D+R+τ×γ (3)

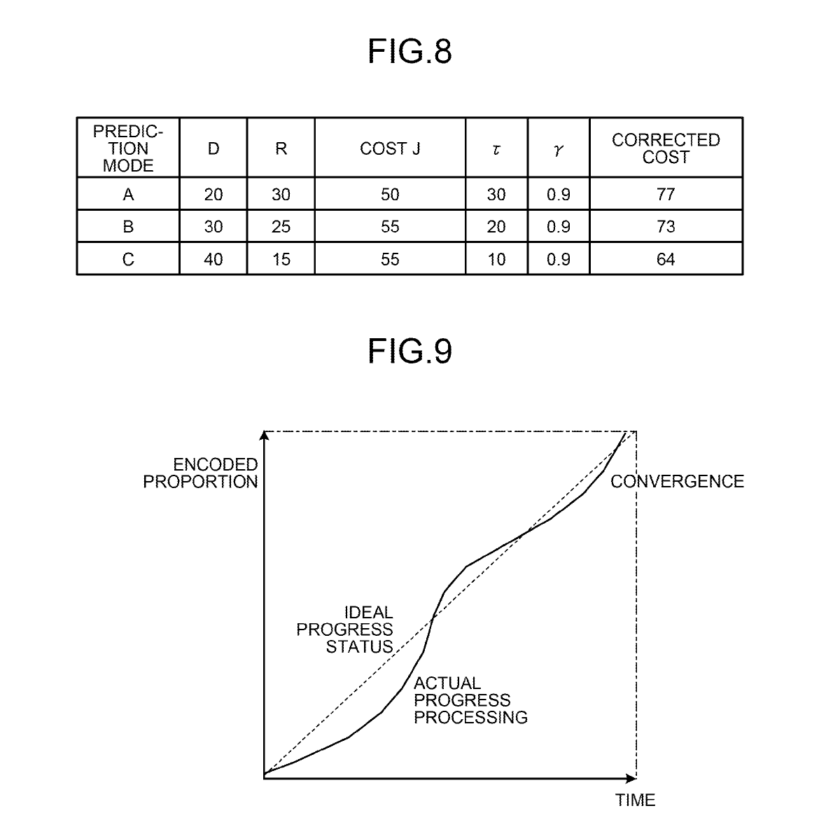

FIG. 8 is a table illustrating an example of corrections on costs. In the example in FIG. 8, for each of encoding modes A to C, distortion D, information R for encoding, cost J, cost correction value τ, coefficient γ, and the corrected cost are illustrated. For example, for encoding mode A, given that distortion D and information R for encoding are “20” and “30”, respectively, adding “20” and “30” results in cost J of “50”. For encoding mode A, given that cost J, cost correction value τ, and coefficient γ are “50”, “30”, and “0.9”, respectively, the corrected cost is “77”. For encoding mode C, given that distortion D and information R for encoding are “40” and “15”, respectively, adding “40” and “15” results in cost J of “55”. For encoding mode C, given that cost J, cost correction value τ, and coefficient γ are “55”, “10”, and “0.9”, respectively, the corrected cost is “64”.

The selector 44 selects the encoding mode for which the corrected cost is small. For example, the selector 44 selects encoding mode C in the case of the example in FIG. 8.

As described above, the video encoding device 10 selects an encoding mode based on the cost corrected by adding, to cost J, a value obtained by multiplying cost correction value τ and coefficient τ in accordance with the progress status of encoding of the frame image. The video encoding device 10 thus recovers from delay by making a large correction when the delay is large in the progress status of encoding of a frame image.

FIG. 9 is a graph representing an example of changes in the progress status of encoding of a frame image. The horizontal axis in FIG. 9 represents the time. The vertical axis in FIG. 9 represents the proportion of a frame image encoded. The broken line in FIG. 9 represents the progress status of ideal processing in encoding each macroblock in a frame image in a frame period. Here, as illustrated in FIG. 9, when the actual progress status in encoding a frame image lags behind the progress status of ideal processing, a large correction is made. Recovery from delay in encoding is thus achieved, and encoding of a frame image is completed in a frame period. Accordingly, a video image can be encoded stably in real time.

### Advantageous Effects

As described above, the video encoding device 10 according to the present embodiment selects an encoding mode for which the corrected cost value obtained by adding to the cost a correction value calculated from information on a processing time taken for an encoding process in an encoding mode and the progress status of the process is smallest. The video encoding device 10 thus can encode a video image stably in real time.

### [c] Third Embodiment

A third embodiment will now be described. The configuration of the video encoding device 10 according to the third embodiment is the same as in the first and second embodiments and the difference is mainly described.

In the present embodiment, the encoding modes are set in ranks in advance in accordance with the processing times for an encoding process. For example, an encoding mode that requires a shorter processing time is associated with a higher rank.

The cost corrector 43 obtains the progress status of encoding for each frame image. For example, the cost corrector 43 calculates coefficient γ indicating the state of delay for each frame image in the same manner as in the second embodiment. The larger the delay is, the smaller value coefficient γ has. The cost corrector 43 selects an encoding mode from the rank associated with the progress status. For example, the cost corrector 43 selects an encoding mode from those higher in the ranks in response to a larger delay in the progress status. For example, the cost corrector 43 determines a higher threshold to the ranks with coefficient γ being smaller in value. The cost corrector 43 then selects an encoding mode from encoding modes at the ranks equal to or higher than the threshold.

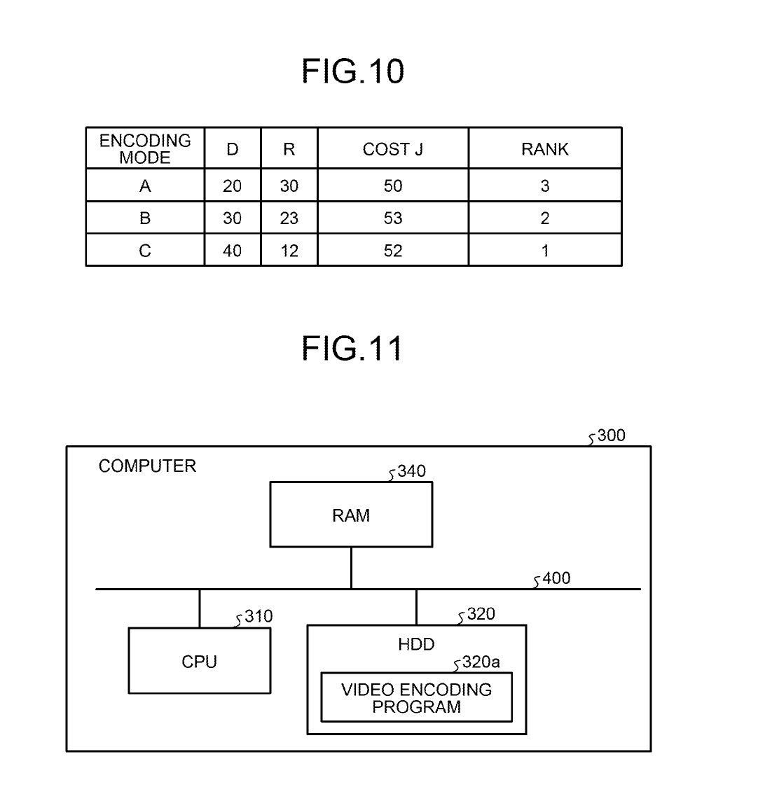

FIG. 10 is a table illustrating an example of corrections on costs. In the example in FIG. 10, distortion D, information R for encoding, cost J, and ranks are illustrated for each of encoding modes A to C. For example, for encoding mode A, distortion D is “20”, information R for encoding is “30”, and the rank is “3”. For encoding mode C, distortion D is “40”, information R for encoding is “12”, and the rank is “1”. In the example in FIG. 10, the smaller the value for the rank is, the higher the rank is.

When the schedule is in progress without delay, the cost corrector 43 calculates the respective costs J by adding distortion D and information R for encoding and selects the encoding mode with the smallest cost. In the example in FIG. 10, the cost corrector 43 selects encoding mode A.

If the delay in schedule is within a threshold, the cost corrector 43 selects an encoding mode with the smallest cost from those with the rank of 2 and higher ranks, excluding the rank of 3. In the example in FIG. 10, the cost corrector 43 selects encoding mode C.

If the delay in schedule is equal to or greater than a threshold, the cost corrector 43 selects the encoding mode with the smallest cost from those with the rank of 1 excluding the ranks of 2 and 3. In the example in FIG. 10, the cost corrector 43 selects encoding mode C.

As described above, the video encoding device 10 selects an encoding mode for encoding each block by excluding an encoding mode with a longer processing time in response to a larger delay of the actual progress status from the progress status of ideal processing in encoding a frame image. The video encoding device 10 thus makes a large correction if the delay in the progress status of encoding of the frame image is large, thereby recovering from the delay.

### Advantageous Effects

As described above, the video encoding device 10 according to the present embodiment excludes an encoding mode with a longer processing time in accordance with the progress status of encoding of a frame image and selects an encoding mode for encoding a block from encoding modes with shorter processing times. The video encoding device 10 thus can encode a video image stably in real time.

### Fourth Embodiment

Embodiments of the disclosed device have been described. The disclosed technique may be carried out in various different modes in addition to the foregoing embodiments. Other embodiments embraced in the present invention will be described below.

For example, although in the foregoing embodiments, H.264 and H.265 are used for video encoding, the encoding format is not limited thereto. For example, any encoding format can be applied as long as an encoding mode is determined by obtaining the cost of encoding for each of a plurality of encoding modes.

The components in each depicted device are functional and conceptual and are not necessarily physically configured as illustrated. That is, a specific state of distribution and integration in each device is not limited to the depicted one and the whole or part thereof may be functionally or physically distributed or integrated in any unit depending on various loads and use conditions. For example, the processing units of the video encoding device 10, such as the mode select controller 21, the subtractor 22, the orthogonal transformer 23, the quantizer 24, the encoder 25, the inverse quantizer 26, the inverse orthogonal transformer 27, the adder 28, and the deblock filter 29 may be integrated as appropriate. The processing units of the mode select controller 21, such as the timer 40, the prediction image generator 41, the cost calculator 42, the cost corrector 43, and the selector 44 may also be integrated as appropriate. The whole or any part of each processing function performed in the processing units may be implemented by a CPU and a computer program analyzed and executed on the CPU or may be implemented as hardware with wired logic.

Video Encoding Program

Various processing described in the foregoing embodiments may also be implemented by executing a computer program prepared in advance on a computer system such as a personal computer or a workstation. An example of the computer system that executes a computer program having the same functions as in the foregoing embodiments will be described below. FIG. 11 is a diagram illustrating a computer that executes a video encoding program.

As illustrated in FIG. 11, a computer 300 includes a central processing unit (CPU) 310, a hard disk drive (HDD) 320, and a random access memory (RAM) 340. Those units 300 to 340 are connected through a bus 400.

In the HDD 320, a video encoding program 320a is stored in advance, which fulfills the same functions as the processing units such as the mode select controller 21, the subtractor 22, the orthogonal transformer 23, the quantizer 24, the encoder 25, the inverse quantizer 26, the inverse orthogonal transformer 27, the adder 28, and the deblock filter 29. The video encoding program 320a may be separated as appropriate.

The HDD 320 also stores a variety of information. For example, the HDD 320 stores an OS and a variety of data used for processing.

The CPU 310 reads out and executes the video encoding program 320a from the HDD 320 to perform the same operation as the processing units in the embodiments. That is, the video encoding program 320a performs the same operation as the processing units in the video encoding device 10.

The video encoding program 320a described above is not necessarily initially stored in the HDD 320.

For example, the program may be stored in a “portable physical medium” such as a flexible disk (FD), a compact disc-read only memory (CD-ROM), a DVD disc, an optomagnetic disk, and an integrated circuit (IC) card inserted in the computer 300. The computer 300 then may read out the program from them for execution.

The program may be stored in, for example, “another computer (or server)” connected to the computer 300 through a public circuit, the Internet, a local area network (LAN), or a wide area network (WAN). The computer 300 may read out the program from them for execution.

According to an aspect of the present invention, a video image can be encoded in real time with less image quality reduction.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A video encoding device comprising:
a processor configured to execute a process comprising:
when successively encoding a plurality of blocks obtained by dividing a frame image in a predetermined period, selecting an encoding mode by which each block is encoded, in accordance with a progress status of encoding of the blocks; and
successively encoding each block of the frame image in the selected encoding mode.

2. The video encoding device according to claim 1, wherein the selecting includes selecting an encoding mode, based on a value obtained by correcting a cost of encoding for each encoding mode with a correction value corresponding to the encoding mode.

3. The video encoding device according to claim 1, wherein the selecting includes selecting, from among encoding modes for each of which a corrected cost value is obtained by adding, to a cost, a correction value calculated from information on a processing time taken for an encoding process in the encoding mode and on a progress status of the process, an encoding mode for which the corrected cost value is the smallest.

4. A video encoding method comprising:
when successively encoding a plurality of blocks obtained by dividing a frame image in a predetermined period, selecting, by a processor, an encoding mode by which each block is encoded, in accordance with a progress status of encoding of the blocks; and
successively encoding, by a processor, each block of the frame image in the selected encoding mode.

5. A non-transitory computer-readable recording medium having stored therein a program for causing a computer to execute a process, the process comprising:
when successively encoding a plurality of blocks obtained by dividing a frame image in a predetermined period, selecting an encoding mode by which each block is encoded, in accordance with a progress status of encoding of the blocks; and
successively encoding each block of the frame image in the selected encoding mode.
